(19) United States
(12) Patent Application Publication
(10) Pub. No.: US 2018/0119336 A1
(43) Pub. Date: May 3, 2018

(54) COMPOSITE YARN

(71) Applicant: AVERY DENNISON RETAIL INFORMATION SERVICES, LLC, Mentor, OH (US)

(72) Inventor: Mathieu DE BACKER, Grottammare (IT)

(21) Appl. No.: 15/800,189

(22) Filed: Nov. 1, 2017

Related U.S. Application Data
(60) Provisional application No. 62/415,875, filed on Nov. 1, 2016.

(51) Int. Cl. D06M 15/564; C09D 175/04; G09F 3/02

(52) U.S. Cl. CPC D06M 15/564; D06M 2101/04; G09F 3/02; C09D 175/04

(57) ABSTRACT

A composite yarn derived from material that is known to be environmentally friendly, and which is then coated with polyurethane is disclosed. Specifically, the composite yarn is derived from ocean waste and then wrapped or twisted with cotton or other materials. The ocean waste comprises recycled PET fibers that are blended with almost any fiber type, but most commonly with cotton, nylon, polyester, hemp, or wool. The composite yarn is then coated with polyurethane to produce a more sustainable coated material. The polyurethane-coated yarn is then used as a base material for care labels, and the total construction is thermal transfer printable, and can be printed with standard inks.

### CROSS REFERENCE TO RELATED APPLICATION(S)

The present application claims priority to and the benefit of U.S. Provisional Patent Application filed Nov. 1, 2016, which is incorporated herein by reference in its entirety.

### BACKGROUND

The present invention relates generally to a composite yarn derived from material that is known to be environmentally friendly, and which is then coated with polyurethane. More particularly, the present disclosure relates to a polyurethane-coated yarn for use as a base material for care labels, creating a more sustainable coated material.

Currently, printed or coated fabric labels are made of conventional yarns that are derived from synthetic fibers or natural fibers, i.e., fibers that are derived from materials grown using chemical fertilizers and/or pesticides. The base materials and the processes used to manufacture these conventional yarns and resulting fabrics that are used in pieces of fabric can have a negative impact on the environment. Furthermore, the resulting printed fabric labels are non-recyclable and non-biodegradable and can have a negative impact on the environment.

Thus, with regard to label production, there is an increasing interest in sustainability and/or environmentally friendly practices. For example, there is a general interest in adopting practices which reduce energy consumption, eliminate the use of carcinogenic and/or hazardous materials, and employ more renewable or recycled source material, etc. In addition, there is a desire to increase the level of personalization and brand identity labeling.

This current desire to increase the level of personalization and brand identity labeling is also being driven by a new level of consciousness related to preserving resources and the environment. Retailers and retail brand owners in an effort to satisfy the demands of consumers have begun seeking new ways to respond to consumer requests as well as delivering an impactful way of maintaining the brand integrity.

In an attempt to overcome the above problems, there is a need for labels that have less of an impact on the environment. The present invention satisfies this need by producing a yarn that, in one embodiment, may be used to construct a composite, coated fabric, derived from material that is known to be environmentally friendly, and which is then coated with polyurethane. The polyurethane-coated yarns can then be used to produce a more sustainable coated material, which can be used as a base material for care labels.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a composite yarn derived from material that is known to be environmentally friendly, and which is then coated with polyurethane. Specifically, the composite yarn is derived from ocean waste and then wrapped or twisted with cotton or other materials. The ocean waste comprises recycled polyethylene terephthalate (PET) fibers that are blended with almost any fiber type, but most commonly with cotton, nylon, polyester, hemp, or wool. The yarn contemplated by the present invention may be used in a fabric which is then coated with a polymer such as polyurethane to produce a more sustainable coated material and a fabric that may be overprinted with variable data.

In a preferred embodiment, the polyurethane-coated yarn is then used as a base material for care labels, and the total construction is thermal transfer printable. Thus, the base material can be printed with standard ink, a soy-based ink, a water-based ink, and/or an ink that is known to inflict little to no harm on the environment.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1A illustrates a prospective view of a polyurethane-coated yarn in accordance with the disclosed architecture.

FIG. 1B illustrates a top view of the composite yarn presently disclosed.

FIG. 2 illustrates a perspective view of the polyurethane-coated yarn in use as a base material for a care label in accordance with the disclosed architecture.

FIG. 3 illustrates further a polyurethane-coated base material contemplated by the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

With regard to label production, there is an increasing interest in sustainability and/or environmentally friendly practices. For example, there is a general interest in adopting practices which reduce energy consumption, eliminate the use of carcinogenic and/or hazardous materials, and employ more renewable or recycled source material, etc. In addition, there is a desire to increase the level of personalization and brand identity labeling.

The present invention satisfies this need by producing a base material, such as yarn. derived from material that is known to be environmentally friendly, and which is then coated with a polymer such as polyurethane. The present invention also contemplates that the base material such as yarn, may be coated with a polyurethane alternative such as any type of wax or oil. In one embodiment, the present invention contemplates that the yarn may be coated with a bio-based polymer or any sort of sustainable polymer. While polyurethane is described throughout the specification, it is noted that the present application is not limited to the use of polyurethane to coat a base layer such as yarn. In addition, the words “environmentally friendly” mean considered to minimize the impact on, or inflict little to no harm on, the environment. Specifically, the base which in one embodiment, may be yarn is derived from ocean waste (i.e., recycled PET fibers) and then wrapped or twisted with cotton or other materials. The composite yarn is then coated with a polymer such as polyurethane. The polyurethane-coated yarns can then be used to produce a more sustainable coated material, which can be used as a base material for care labels.

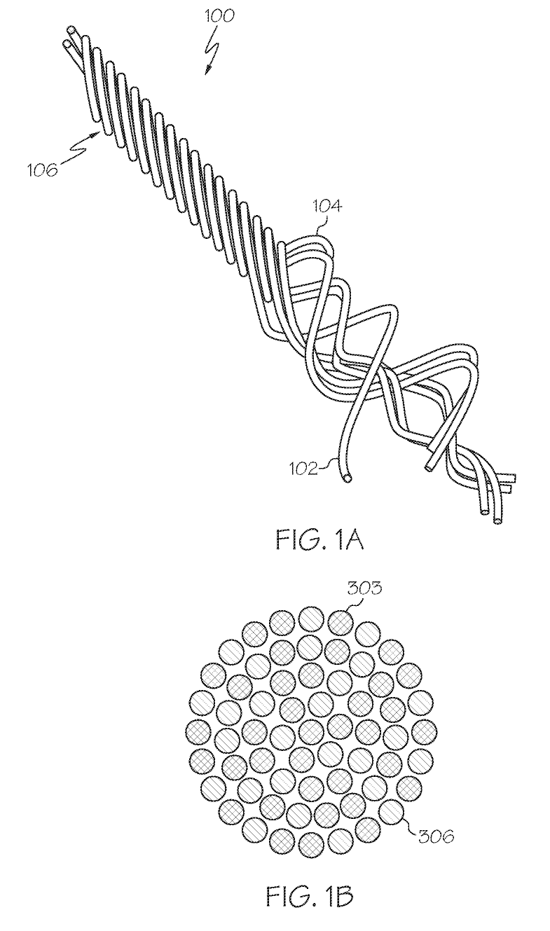

Referring initially to the drawings, FIG. 1A illustrates a yarn 100 derived from material that is known to be environmentally friendly, and which is then coated with polyurethane for use as a base material for care labels and other items. Using the polyurethane-coated yarn 100 as a base material for care labels is merely one possible example and the same composite yarn 100 may be used for any suitable application. Thus, although the term “yarn” is used throughout the present disclosure for exemplary purposes, the term “yarn” may be any single item, or a group of items or materials.

The composite yarn 100 comprises material that is known to be environmentally friendly, and which is then coated with polyurethane 106. Specifically, the composite yarn 100 is derived from ocean waste (102 PET fibers) and then wrapped or twisted with cotton 104 or other materials as illustrated in FIG. 1B which illustrated a top view of the composite yarn. FIG. 1B illustrates plastic fibers 305 intertwined with cotton fibers 306. The ocean waste comprises recycled polyethylene terephthalate (PET) fibers 102. More specifically, plastic bottles, consumer packaging, or other similar beverage bottles, and other items are recovered from the ocean to reprocess into the PET fibers 102. For example, the plastic bottles are sorted by color and all foreign and non-PET material such as bottle caps are removed so that only bottles formed of PET material remain. The bottles are sterilized, dried, and crushed into chips which are washed. Chips from clear bottles are bleached, whereas chips from colored bottles, typically green, are not. When the chips are dry, they are heated and forced through a spinneret to form a fiber form or tow. The tow is pulled through heated rollers of a drawing machine to form smooth strings of PET. The tow is passed through a crimping machine and then cut into lengths of a few inches to form recycled PET fibers 102.

The recycled PET fibers 102 are then blended with almost any fiber 104 type (synthetic or natural), but most commonly with cotton, nylon, polyester, hemp, or wool, or any other suitable fiber type to form a recycled yarn such as DPX® or other yarns from Bionic®. The amount of cotton fibers 104 or other fibers blended with the recycled PET fibers 102 is greater than the amount of recycled PET fibers 102. For example, the yarn may comprise 65-70% regenerated cotton fibers 104, with the balance comprising recycled PET fibers 102. Composite yarn 100 formed from regenerated cotton fibers 104 and recycled PET fibers 102 is coarser than yarn formed from regenerated cotton fibers and hemp fibers. This is due to the fact that it is more difficult to spin PET strands into uniformly thin fibers. Moreover, the yarn including the PET fibers typically contains some contamination of color, thus, the yarn or fabric woven from the yarn when dyed does not always maintain a uniform color.

The composite yarn 100 is then coated with polyurethane 106 to produce a more sustainable coated material. Specifically, the composite yarn 100 can be coated with any suitable material, but most preferably polyurethane 106. This creates a total construction that is thermal transfer printable.

The composite yarns 100 used may be monofilament yarns, multifilament yarns, spun yarns, etc. as desired, and the fibers which make up the yarns 100 can be made from artificial, natural or synthetic fibers depending on the user's needs or wants, and/or manufacturing constraints. The composite yarns 100 may also be elastic or non-elastic yarn, or various combinations thereof. The type of composite yarns 100 used within the base material and the number of composite yarns 100 may be varied over wide ranges and will be primarily controlled by the desired end use for the base material. Typically, the composite yarns 100 comprise threads that have a denier of from 50 Dtex to 300 Dtex and preferably between 50 Dtex and 100 Dtex. However, the present invention is not limited to any sort of particular thread with any sort of denier value.

The polyurethane-coated yarn 100 is then used as a base material for care labels and other suitable items. Furthermore, the total construction is thermal transfer printable, and can be printed with standard inks, soy-based inks, water-based inks, and/or inks that are known to inflict little to no harm on the environment.

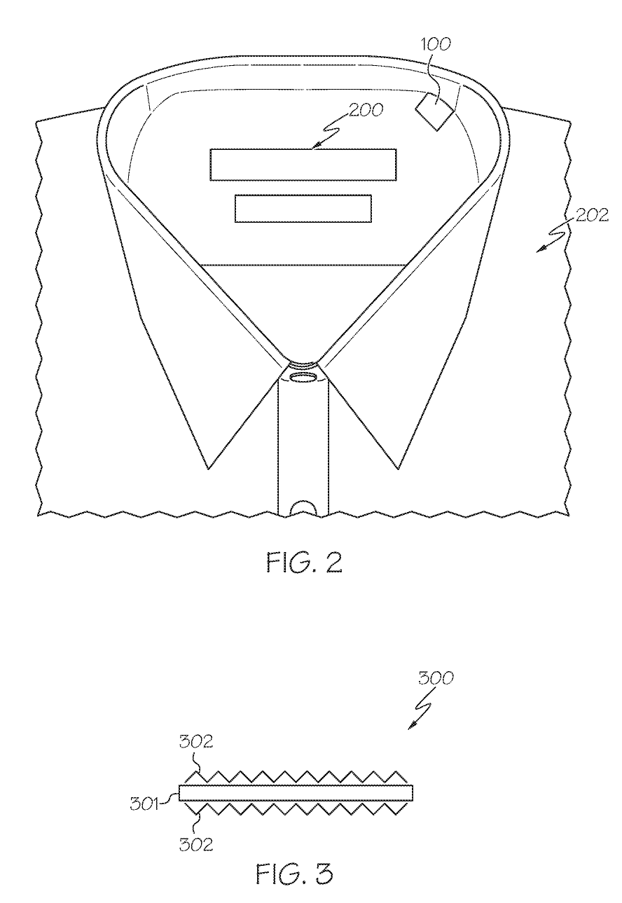

Additionally, the base material can be any suitable size, shape, and pattern as is known in the art without affecting the overall concept of the invention. One of ordinary skill in the art will appreciate that the size and/or shape of the base material as shown in FIG. 2 is for illustrative purposes only and many other sizes and/or shapes of the base material are well within the scope of the present disclosure. Although dimensions of the base materials (i.e., length, width, and height) are important design parameters for good performance, the base material may be any size and/or shape based on user preference and/or manufacturing concerns. FIG. 3 of the present invention illustrates the polymer coated 302 base material such as yarn 301 that forms the composite structure 300. A plurality of the composite structure or yarn 300 may be used to construct a printable fabric.

FIG. 2 illustrates the polyurethane-coated yarn 100 in use as a base material for a care label 200, such as those labels found on the interior of a garment 202 to help with branding. Most garments 202 or apparel items contain at least one brand identifier, product data or other information. The brand identifier may be printed, imaged or fully woven fabric, to create a brand identification label or tag. For example, these labels may contain any one or more of the following pieces of information; brand name, logo, fiber content, country of origin, care instructions manufacturer codes, production lot, etc.

The polyurethane-coated yarn 100 can be used as the base material for such a care label 200 and any pattern and/or design can be woven and/or printed on the care label 200 and the pattern and/or design can be of any shape or size. There can be a plurality of the same pattern and/or design, or a mixture of patterns and/or designs. Large patterns and/or designs can be utilized or small patterns and/or designs, or combinations of both large and small patterns and/or designs can be utilized. Furthermore, the total construction of the base material is thermal transfer printable, and can be printed with standard inks, soy-based inks, water-based inks, and/or inks that are known to inflict little to no harm on the environment, instead of woven designs. Any size and/or shaped care labels 200 can be created with the polyurethane-coated yarn 100.

The present invention contemplates that the composite wrapped base material, such as yarn, of the present invention may be utilized in a fabric for a care label or even in any sort of garment, accessory, shoe wear available in the market. The composite material presently disclosed is not limited in its available utilization.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A composite yarn for producing care labels, comprising:
a yarn comprising a grouping of composite fibers; and
a polyurethane layer;
wherein the yarn is coated with the polyurethane layer to produce a more sustainable coated material.

2. The composite yarn of claim 1, wherein the yarn comprises ocean waste fibers blended with a fiber material.

3. The composite yarn of claim 2, wherein the ocean waste fibers comprise recycled plastic beverage containers.

4. The composite yarn of claim 3, wherein the recycled plastic beverage containers are reduced to polyethylene terephthalate (PET) fibers.

5. The composite yarn of claim 4, wherein the fiber material comprises at least one of cotton, nylon, polyester, hemp, or wool.

6. The composite yarn of claim 5, wherein an amount of fiber material is greater than an amount of PET fibers in the yarn.

7. The composite yarn of claim 6, wherein the amount of fiber material is approximately between 65-70% of the yarn.

8. The composite yarn of claim 1, wherein construction of the yarn coated with the polyurethane layer produces a thermal transfer printable.

9. The composite yarn of claim 1, wherein the yarn coated with the polyurethane layer is used in a fabric material.

10. A composite yarn for producing care labels, comprising:
a yarn comprising ocean waste fibers blended with a fiber material; and
a polyurethane layer;
wherein the yarn is coated with the polyurethane layer to produce a more sustainable coated material.

11. The composite yarn of claim 10, wherein the yarn coated with the polyurethane layer is used as a base material for a care label.

12. The composite yarn of claim 10, wherein the ocean waste fibers comprise recycled plastic beverage containers.

13. The composite yarn of claim 12, wherein the recycled plastic beverage containers are reduced to PET fibers.

14. The composite yarn of claim 13, wherein the fiber material comprises at least one of cotton, nylon, polyester, hemp, or wool.

15. The composite yarn of claim 14, wherein an amount of fiber material is greater than an amount of PET fibers in the yarn.

16. The composite yarn of claim 15, wherein the amount of fiber material is approximately between 65-70% of the yarn.

17. The composite yarn of claim 10, wherein construction of the yarn coated with the polyurethane layer produces a thermal transfer printable.

18. A yarn for producing care labels, comprising:
a yarn comprising recyclable PET fibers blended with a fiber material; and
a polyurethane layer;
wherein the yarn is coated with the polyurethane layer and the yarn is utilized in a composite fabric.

19. The composite yarn of claim 18, wherein the fiber material comprises at least one of cotton, nylon, polyester, hemp, or wool.

20. The composite yarn of claim 18, wherein the yarn coated with the polyurethane layer is used as a base material for a care label.
